(19) United States
(12) Patent Application Publication
(10) Pub. No.: US 2016/0145121 A1
(43) Pub. Date: May 26, 2016

(54) Decontamination Unit For A Potentially Pathogenic Fluid And Decontamination Installation Including Such A Unit

(71) Applicant: ACTINI, Maxilly Sur Leman (FR)

(72) Inventor: Frédéric Laurent DE STOUTZ, Larringes (FR)

(73) Assignee: ACTINI, Maxilly Sur Leman (FR)

(21) Appl. No.: 14/899,346

(22) PCT Filed: Jun. 16, 2014
(86) PCT No.: PCT/EP2014/062543

§ 371 Date: Dec. 17, 2015

(30) Foreign Application Priority Data
Jun. 18, 2013 (FR) 1355689

(51) Int. Cl. C02F 1/02

(52) U.S. Cl. CPC C02F 1/02; C02F 2303/04; C02F 2103/003

(57) ABSTRACT

The invention relates to a decontamination unit (19) for potentially pathogenic fluids including a treatment tank (29) and at least one heating element (31). The treatment tank (29) includes a flat bottom (33) and at least one heating element (31) fastened on the outer side (35) of the flat bottom (31) opposite the lower side (37) designed to come into contact with the potentially pathogenic fluid.

The present invention relates to a decontamination unit for a potentially pathogenic fluid and to a decontamination installation comprising such a unit.

The invention is notably applicable in the context of units for treating effluent that is potentially contaminated with germs or infectious agents such as viruses, bacteria, parasites (protozoaires, helminths) or even proteins of the prion type.

In laboratories or hospitals, personnel are often in contact (admittedly this is generally indirect contact via gloves) with potentially pathogenic fluids after taking samples or handling substances in the context of their work or have to handle objects, for example containers or test tubes, which have been in contact with such a pathogenic fluid, requiring them to wash objects or parts of the body that have been in contact with the pathogenic fluid under water for example.

The water that has been used for the washing/cleaning is therefore potentially contaminated and cannot be sent to the drains without a decontamination operation having been performed beforehand.

For this reason, in most laboratories and hospitals, the water points, notably the sinks, are connected to an effluent circuit leading to a central decontamination installation.

However, depending on the size of the laboratories, hospitals or research centers and the precise activities carried out there, the quantities of water used are small and investment in a central thermal decontamination treatment installation is too high, especially since the building needs to be provided with a specific circuit for the potentially contaminated water in parallel with the standard waste water circuit.

Other establishments that have several laboratories prefer not to centralize the collection of effluent for treatment in common in order not to run the risk of “breaking” the containment of the room and prefer to perform treatment in situ.

In order to alleviate this problem it is known practice to provide a local and self-contained small-sized decontamination installation.

However, the known installations are not satisfactory.

Specifically, document JPH03157185 discloses an installation comprising two decontamination units so that the contaminated water can be received in one unit while the other unit is heating during a decontamination cycle.

Now, this installation is fairly expensive given that two complete decontamination units with their own heating, control and valve elements need to be provided. Furthermore, this installation requires the use of a pump to circulate the potentially contaminated fluids and this generates noise and may present safety problems should the pump seals fail.

In addition, the heating element 9a or 9b of that document enters the decontamination tank directly, and this presents two disadvantages.

Specifically, the heating body is directly in contact with the contaminated fluid so that limescale may be deposited directly on the heating elements and thereafter reduce the heat transfer, resulting in a higher and needless energy expenditure and a risk that the heating temperature required for effective decontamination (for example 135° C.) is no longer achieved. In addition, these heating elements are difficult to maintain given that they are mounted built into the tank and that they have been in contact with the potentially pathogenic fluids.

Furthermore, the applicant has noticed a temperature gradient between the top and bottom of the tank of the aforementioned document, and this too constitutes a risk given that the decontamination conditions for the fluid at the bottom of the tank have probably not been adhered to as a result of too low a temperature.

In order to at least partially alleviate the defects mentioned hereinabove, one subject of the invention is an improved decontamination unit.

To this end, one subject of the invention is a decontamination unit for potentially pathogenic fluids, comprising a treatment tank and at least one heating element, characterized in that the treatment tank comprises a fiat bottom and at least one heating element fixed to the external side of the flat bottom which is the opposite to the internal side intended to be in contact with the potentially pathogenic fluid, characterized in that the fiat bottom of the treatment tank is inclined.

Thus, by fixing the heating elements directly against the bottom, of the volume of the treatment tank, these elements are no longer in contact with the potentially pathogenic fluid. The result of this is that there is no longer any formation of limescale or boiler scale on the heating elements, which means that their efficiency is not impaired over time. In addition, because of the layout of the heating elements, more uniform heating of the potentially pathogenic fluid is ensured and dead zones avoided.

By virtue of the inclined bottom, the limescale or boiler scale which stay form on the bottom will accumulate at the bottom of the slope from where it can then be removed at the end of the decontamination cycle together with the decontaminated fluid.

In addition, by inclining the bottom in this way, when the heating elements perform the heating, a circular movement (from the bottom to the top) of the potentially pathogenic fluid is induced in the treatment tank and contributes to a very uniform heating of this fluid, something which is important in order to ensure correct decontamination of the infectious agents in the fluid. Thus, this uniform heating can be ensured without an additional electric motor, making it less expensive and also more reliable from a maintenance standpoint.

The invention may further comprise one or more of the following features considered alone or in combination:

The flat bottom of the treatment tank may be inclined between 5%-10%, preferably by 7%.

According to another aspect, an outlet of the treatment tank is formed at the inclined fiat bottom, at the bottom, of the slope.

The heating element is for example a circular flat resistance.

According to another aspect, the unit comprises several, at least two, concentric flat resistances.

According to another aspect, the treatment tank is made of stainless steel, preferably of type 316L.

The invention also relates to a decontamination installation comprising
a sink for collecting the potentially pathogenic fluids,
a storage tank for the potentially pathogenic fluid collected, connected fluidically to the sink,
a decontamination unit as described hereinabove, the inlet of which is fluidically connected to the outlet of the storage tank, and
a heat exchanger the inlet of which is fluidically connected to the outlet of the decontamination unit.

According to one aspect, the sink is positioned above the storage tank, the storage tank is positioned above the decontamination unit, and the decontamination unit is positioned above the heat exchanger so that circulation of the potentially pathogenic fluids in the installation is achieved under gravity.

According to another aspect, the installation comprises a first regulating valve positioned in a pipe connecting the storage tank to the decontamination unit and a second regulating valve positioned in a pipe connecting the decontamination unit to the heat exchanger.

The invention also relates to a method for decontaminating potentially pathogenic fluids in a decontamination unit as described hereinabove, characterized in that
the treatment tank is filled with a potentially pathogenic fluid, leaving a gaseous expansion volume inside the treatment tank,
the potentially pathogenic fluid is heated to a temperature of between 130° C. and 140° C., preferably to 135° C., for a duration of between 1.5 min and 3 min, preferably for 2 min, allowing the pressure in the treatment tank to increase,
the fluid thus decontaminated is discharged.

Further features and advantages will become apparent from reading the following description of the figures in which:

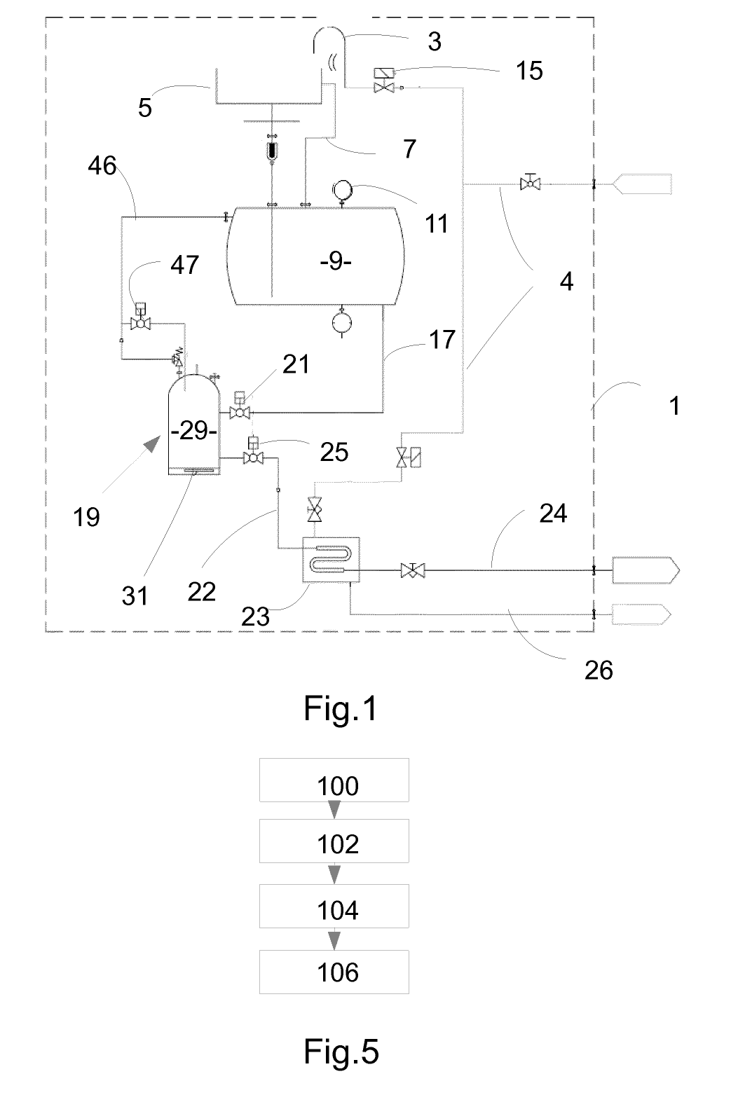

FIG. 1 is an outline diagram of the decontamination installation according to one embodiment,

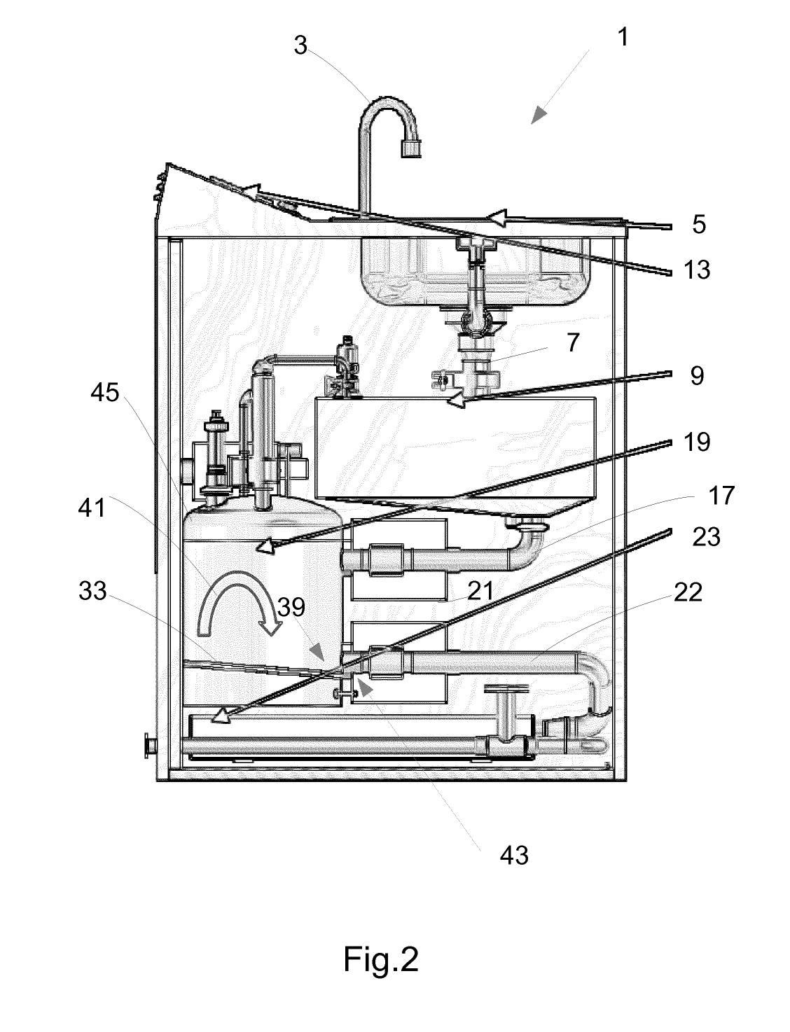

FIG. 2 is a schematic side view of one embodiment of the decontamination installation according to one embodiment,

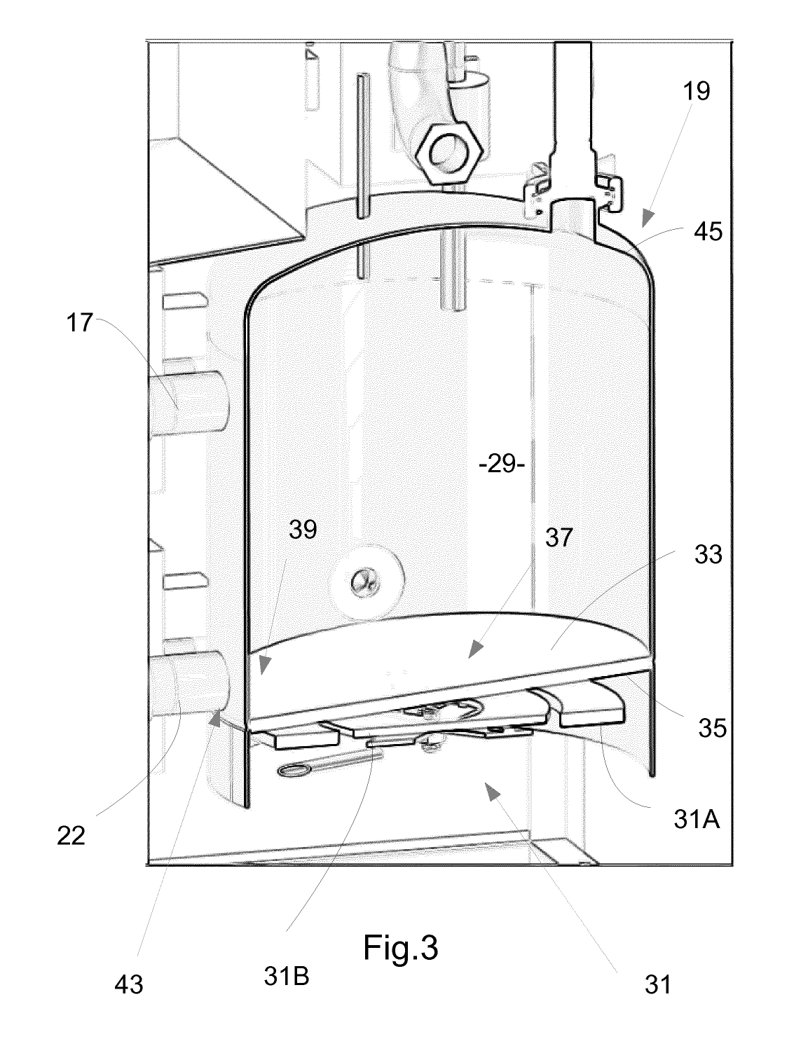

FIG. 3 shows a detail of FIG. 2, particularly the decontamination unit according to one embodiment,

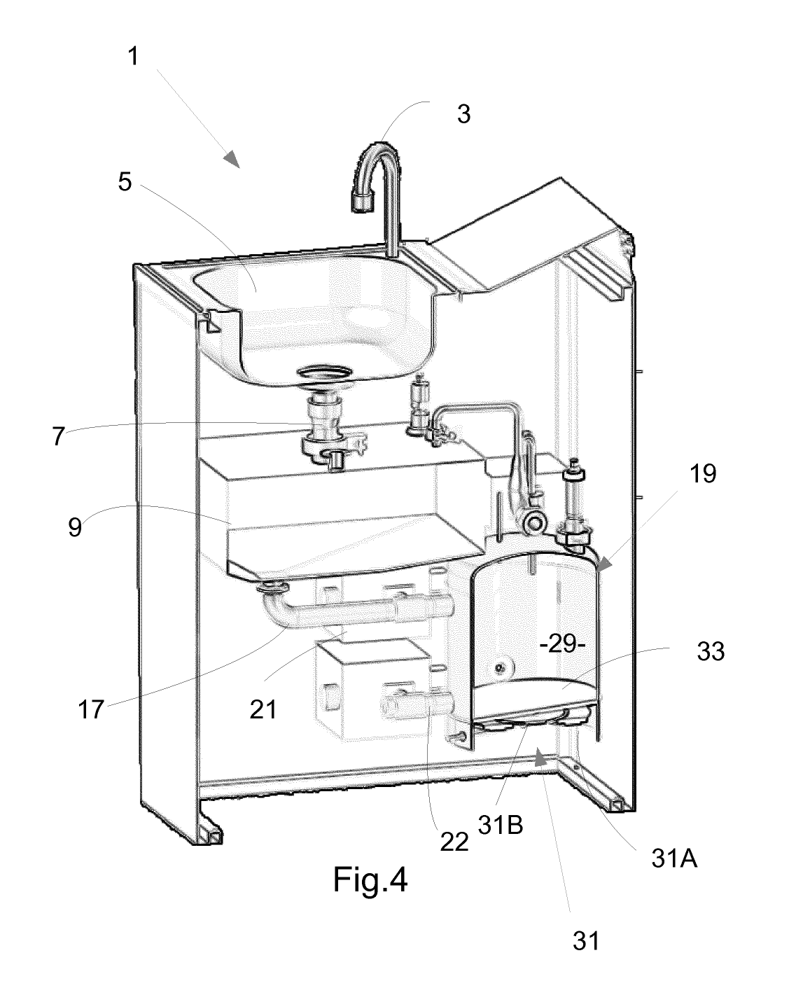

FIG. 4 is a schematic view in cross section of one embodiment of the decontamination installation according to one embodiment, and

FIG. 5 is a flow diagram showing one example of various steps in a decontamination method.

In all the figures, the same elements bear the same reference numerals.

One embodiment of the present invention will be described hereinafter with reference to the various figures.

FIG. 1 shows an outline diagram of a decontamination installation 1 according to one embodiment, and FIG. 2 shows a schematic side view of one embodiment of the decontamination installation 1.

Thus, the decontamination installation 1 for example comprises a mains water tap 3 connected to a mains water inlet 4 for the precleaning or washing of objects, for example test tubes. For preference, the tap can be operated contactlessly, for example via an infrared sensor or a capacitive sensor. Above the outlet of the tap 3 there is a sink 5 for collecting the potentially pathogenic fluids, namely the residues from test tubes containing for example infectious agents. The sink 5 is, for example, made of type 304 stainless steel.

The outlet of the sink 5 is connected by a discharge pipe 7 to the inlet of a storage tank 9 placed below the sink 5 so that the potentially pathogenic and contaminated fluids are discharged under gravity into the storage tank 9.

This storage tank 9 is for example made of type 316L stainless steel and may have a capacity for example of 251.

As can be seen in FIG. 1, the storage tank 9 is equipped. with a level sensor 11. The latter is connected to a control unit (control panel 13 visible in FIG. 2 to sense the level in the storage tank 9 and, according to the level reached, trigger a decontamination cycle and, if appropriate, block a stop valve 15 for the mains water supplying the tap 3 so as to prevent pathogenic fluid from overflowing in the sink 5.

The outlet of the storage tank 9 is connected by a pipe 17 to a decontamination unit 19 which is positioned below the storage tank 9 so that the potentially pathogenic fluids pour under gravity into the decontamination unit 19. A regulating valve 21 positioned in the pipe connecting the storage tank 9 to the decontamination unit 19 allows the flow to be regulated, for example for the filling of the decontamination tank 19, and is controlled by the control unit 13.

The outlet of the decontamination unit 19 is connected via a pipe 22 to an inlet of a heat exchanger 23 intended to cool the decontaminated fluid leaving the decontamination unit 19. Another inlet of the heat exchanger 23 is connected to the mains water.

The heat exchanger 23 has two outlets; an outlet 24 for decontaminated and cooled fluid and an outlet 26 for mains water used as coolant in the heat exchanger 23. Thus, the mains water is always separate from the pipes carrying the decontaminated fluid so that there is no possibility of return contamination, thereby increasing the safety of the installation described here still further.

as may be seen in FIG. 2, the heat exchanger 23, of elongate shape to maximize exchange areas, is positioned under the decontamination unit 19 so that the decontaminated fluid leaving the decontamination unit 19 can also pass through it under gravity.

A regulating valve 25 (FIG. 1) positioned in the pipe 22 connecting the decontamination unit 19 to the heat exchanger 23 allows the flow to be regulated, for example for emptying the decontamination tank 19, and is controlled by the control unit 13.

The decontamination unit 19 for potentially pathogenic fluids will now be described in greater detail.

This decontamination unit 19 comprises a treatment tank 29, for example made of stainless steel, preferably of type 316L, and at least one heating element 31, preferably several heating elements. The volume of the treatment tank is, for example, 121.

As can be seen in FIGS. 2 to 4, the treatment tank 29 comprises a flat or planar tank bottom 33 and two flat, circular and concentric heating elements 31A and 31B (see FIGS. 3 and 4), for example with a power of 2.3 kW, are fixed, for example bolted in a cross, to the external side 35 of the flat bottom 33 which is the opposite side to the internal side 37 intended to be in contact with the potentially pathogenic fluid.

Thus, by fixing the heating elements 31A and 31B directly against the bottom of the volume of the treatment tank 29, these elements are no longer in contact with the potentially pathogenic fluid. The result of this is that there is no longer any formation of limescale or boiler scale on the heating elements which means that their efficiency is not impaired over time. In addition, the layout of the heating elements ensures more uniform heating of the potentially pathogenic fluid and dead zones are avoided.

As can be seen in FIGS. 2 to 4, the flat bottom 33 of the treatment tank 29 is inclined, for example between 5%-10%, preferably by 7% (which means to say at an angle of 4° to the horizontal).

The consequence of this is that the limescale or boiler scale which may form on the bottom will accumulate at the bottom of the slope (see arrow 39) and then be discharged at the end of the decontamination cycle with the decontaminated fluid.

In addition, because of this inclination of the bottom, as the heating elements 31A and 31B perform heating, a circular movement (from the bottom to the top) of the potentially pathogenic fluid is induced in the treatment tank 29 (see arrow 41 in FIG. 2) and this contributes to highly uniform heating of this fluid, something which is important for ensuring correct decontamination of the infectious agents in the fluid.

Furthermore, the outlet 43 of the treatment tank 29 is created at the bottom of the inclined plane 33, at the bottom of the slope, thereby encouraging the removal of residue or particles (for example boiler scale or limescale) after a decontamination cycle.

Furthermore, the top of the treatment tank 29 is in the shape of a dome 45 in order to act as an expansion vessel during heating. Thus, during the heating, the pressure in the treatment tank 29 will increase to around 3.5 bar. This pressure is then used to empty the treatment tank 29 after a decontamination cycle.

The treatment tank 29 is furthermore equipped with a low level sensor, with a safety relief valve (for example rated at 7 bar) and with two temperature probes, one at the bottom for regulating the heating temperature and one at the top for validating that the setpoint temperature has indeed been reached.

A pipe 46 between the dome 45 of the treatment tank 29 and the storage tank 9 and fitted with a regulating valve 47 allows the pressures between these two tanks to be equalized, notably during the filling of the treatment tank 29.

One example of the operation of the installation 1 described hereinabove will now be described on the assumption that the storage tank 9 has been filled with a potentially pathogenic fluid to a level that triggers a decontamination cycle, and with reference to FIG. 5.

In a first step 100, the treatment tank 29 is filled with a potentially pathogenic fluid, leaving a gaseous expansion volume inside the treatment tank 29 in the region of the dose 45. In this particular example, the treatment volume is just 81, in order to leave a gaseous volume free for expansion.

Then, in a second step 102, the potentially pathogenic fluid is heated to a temperature of between 130° C. and 140° C., preferably to 135° C. for a duration of between 1.5 min and 3 min, preferably for 2 min, letting the pressure in the treatment tank, for example here around 3.5 bar, increase. It will be noted that the pressure in the treatment tank 29 is not regulated and is simply the result of the heating temperature, the duration of the heating of the fluid in the treatment tank 29 and the volume of potentially pathogenic fluid admitted to the treatment tank, all of which parameters are chosen so that the pressure in the treatment tank 29 remains below the rated pressure of the safety relief valve, the latter operating only in the event of a problem, for example in the event of overheating.

Finally, in a step 104, the fluid thus decontaminated is discharged using the pressure that has built up during the heating.

The decontaminated fluid is then cooled during a step 106 in the heat exchanger 23.

By virtue of the design of the present installation, the latter produces practically no noise given that it has no pump(s) for circulating the fluids.

It will therefore be appreciated that the decontamination unit allows effective decontamination and offers increased reliability. In addition, maintenance thereof is easy and presents no particular difficulties.

1. A decontamination unit for potentially pathogenic fluids, comprising a treatment tank and at least one heating element, characterized in that the treatment tank comprises a flat bottom and at least one heating element fixed to the external side of the flat bottom which is the opposite to the internal side intended to be in contact with the potentially pathogenic fluid, characterized in that the flat bottom of the treatment tank is inclined.

2. The decontamination unit as claimed in claim 1, characterized in that the flat bottom of the treatment tank is inclined between 5%-10%, preferably by 7%.

3. The decontamination unit as claimed in claim 1, characterized in that an outlet of the treatment tank is formed at the inclined flat bottom, at the bottom of the slope.

4. The decontamination unit as claimed in claim 1, characterized in that the heating element is a circular flat resistance.

5 . The decontamination unit as claimed in claim 4, characterized in that it comprises several, at least two, concentric flat resistances.

6. The decontamination unit as claimed in claim 1 characterized in that the treatment tank is made of stainless steel, preferably of type 316L.

7. A decontamination installation comprising
a sink for collecting the potentially pathogenic fluids,
a storage tank for the potentially pathogenic fluid collected, connected fluidically to the sink,
a decontamination unit as claimed in claim 1, the inlet of which is fluidically connected to the outlet of the storage tank, and
a heat exchanger the inlet of which is fluidically connected to the outlet of the decontamination unit.

8. The decontamination installation as claimed in claim 7, characterized in that the sink is positioned above the storage tank, in that the storage tank is positioned above the decontamination unit, and in that the decontamination unit is positioned above the heat exchanger so that circulation of the potentially pathogenic fluids in the installation is achieved under gravity.

9. The installation as claimed in claim 7, characterized in that it comprises a first regulating valve positioned in a pipe connecting the storage tank to the decontamination unit and a second regulating valve positioned in a pipe connecting the decontamination unit to the heat exchanger.

10. A method for decontaminating potentially pathogenic fluids in a decontamination unit as claimed in claim 1, characterized in that
the treatment tank is filled with a potentially pathogenic fluid, leaving a gaseous expansion volume inside the treatment tank,
the potentially pathogenic fluid is heated to a temperature of between 130° C. and 140° C., preferably to 135° C., for a duration of between 1.5 min and 3 min, preferably for 2 min, allowing the pressure in the treatment tank to increase,
the fluid thus decontaminated is discharged.

11. A decontamination unit comprising:
a treatment tank configured to hold potentially pathogenic fluids, said treatment tank having an internal surface adapted to be in contact with the potentially pathogenic fluid and said treatment tank having a base portion with a substantially flat inclined internal surface;
said treatment tank having a bottom external surface which is flat; and
at least one heating element disposed between an external surface of the base portion and the bottom external surface of said treatment tank.

12. The decontamination unit as claimed in claim 1, wherein the substantially flat inclined internal surface of the treatment tank is inclined between 5%-10%.

13. The decontamination unit as claimed in claim 1, wherein said treatment tank is provided having an outlet at a bottom of the slope formed by the substantially flat inclined internal surface of the bottom portion of said treatment tank.

14. The decontamination unit as claimed in claim 1, wherein the heating element is provided having a circular shape.

15. The decontamination unit as claimed in claim 1, wherein the heating element comprises at least two concentrically arranged heating elements.

16. The decontamination unit as claimed in claim 1 wherein said treatment tank is made of stainless steel.

17. A decontamination installation comprising:
a sink configured to collect potentially pathogenic fluids,
a storage tank in fluid communication with said sink, said storage tank configured to hold potentially pathogenic fluids collected in said sink;
a decontamination unit having an inlet in fluid communication with an outlet of said storage tank, said decontamination unit comprising:
a treatment tank configured to hold potentially pathogenic fluids, said treatment tank having an internal surface adapted to be in contact with the potentially pathogenic fluid and said treatment tank having a base portion with a substantially flat inclined internal surface; and
said treatment tank having a bottom external surface which is flat; and
at least one heating element disposed between an external surface of the base portion and the bottom external surface of said treatment tank; and
a heat exchanger having an inlet in fluid communication with the outlet of the decontamination unit.

18. The decontamination installation as claimed in claim 17, wherein:
the sink is positioned above the storage tank;
the storage tank is positioned above the decontamination unit; and
the decontamination unit is positioned above the heat exchanger so that circulation of the potentially pathogenic fluids in the installation is achieved under gravity.

19. The installation as claimed in claim 17, further comprising:
a first pipe coupled to provide fluid communication between said storage tank and said decontamination unit;
a first regulating valve positioned in said first pipe;
a second pipe coupled to provided fluid communication between said decontamination unit and said heat exchanger; and
a second regulating valve positioned in said second pipe.

20. A method for decontaminating potentially pathogenic fluids in a decontamination unit as claimed in claim 11, characterized in that
the treatment tank is filled with a potentially pathogenic fluid, leaving a gaseous expansion volume inside the treatment tank,
the potentially pathogenic fluid is heated to a temperature of between 130° C. and 140° C., preferably to 135° C, for a duration of between 1.5 min and 3 min, preferably for 2 min, allowing the pressure in the treatment tank to increase,
the fluid thus decontaminated is discharged.
